(19) United States
(12) Patent Application Publication
(10) Pub. No.: US 2022/0413176 A1
(43) Pub. Date: Dec. 29, 2022

(54) Annulus Velocity Independent Time Domain Structure Imaging In Cased Holes Using Multi-Offset Secondary Flexural Wave Data

(71) Applicant: Halliburton Energy Services, Inc., Houston, TX (US)

(72) Inventors: Amit Padhi, Houston, TX (US); Quingtao Sun, Spring, TX (US)

(73) Assignee: Halliburton Energy Services, Inc., Houston, TX (US)

(21) Appl. No.: 17/360,423

(22) Filed: Jun. 28, 2021

(51) Int. Cl. G01V 1/50; G01V 1/46

(52) U.S. Cl. CPC G01V 1/50; G01V 1/46

(57) ABSTRACT

A method and system for logging. The method may include disposing an acoustic logging tool into a wellbore, insonifing a pipe string within the wellbore with the acoustic logging tool, recording a plurality of flexural waves with the acoustic logging tool as one or more traces, and identifying a condition of a material behind the pipe string using the plurality of flexural waves. The acoustic logging tool may include one or more transmitters for insonifing a pipe string within a wellbore and one or more receivers configured to record a plurality of flexural waves. Additionally an information handling system may be configured to identify a condition of a material behind the pipe string using the plurality of flexural waves.

### BACKGROUND

For oil and gas exploration and production, a network of wells, installations and other conduits may be established by connecting sections of metal pipe together. For example, a well installation may be completed, in part, by lowering multiple sections of metal pipe (i.e., a casing string) into a wellbore, and cementing the casing string in place. In some well installations, multiple casing strings are employed (e.g., a concentric multi-string arrangement) to allow for different operations related to well completion, production, or enhanced oil recovery (EOR) options.

During a well installation's life, logging operations may be performed to determine material behind a pipe string. These operations may be performed by a variety of logging tools that may utilize acoustic methods or electromagnetic methods to identify material behind a pipe string. However, the tools utilized often only utilize one form of measurement. Additionally, the accuracy with predicting the material behind casing is often low as human determination of recorded data may be faulty.

### BRIEF DESCRIPTION OF THE DRAWINGS

These drawings illustrate certain aspects of some examples of the present disclosure and should not be used to limit or define the disclosure.

FIG. 1 illustrates a system including an acoustic logging tool;

FIG. 2 illustrates an acoustic logging operation;

FIG. 3 illustrates an example of a transmitter and a receiver configuration;

FIG. 4 illustrates a graph of multiple traces captured by multiple receivers on the acoustic logging tool;

FIG. 5 illustrates a processing of the multiple traces from FIG. 4; and

FIG. 6 illustrates a final waveform created from the multiple traces in FIG. 5.

### DETAILED DESCRIPTION

This disclosure may generally relate to methods for identifying a condition of a material behind a pipe string with an acoustic logging tool. Acoustic sensing may provide continuous in situ measurements of parameters related to determining the condition of the material behind a pipe string. As a result, acoustic sensing may be used in cased borehole monitoring applications. As disclosed herein, acoustic logging tools may be used to emit an acoustic signal which may be reflected and/or refracted off different interfaces inside a wellbore.

During material evaluation operations, the acoustic logging tool may utilize multiple receivers to record flexural wave data. This may allow for improved evaluation of the conditions in the annulus of the material which may not be possible with ultrasonic pulse-echo systems or ultrasonic flexural wave data acquisition systems that utilize single receiver data. Using a time domain imaging algorithm, the proposed idea in this disclosure takes in waveform data from multi-offset receivers, flattens the shot gather and then stacks them to generate images of the annulus with high fidelity.

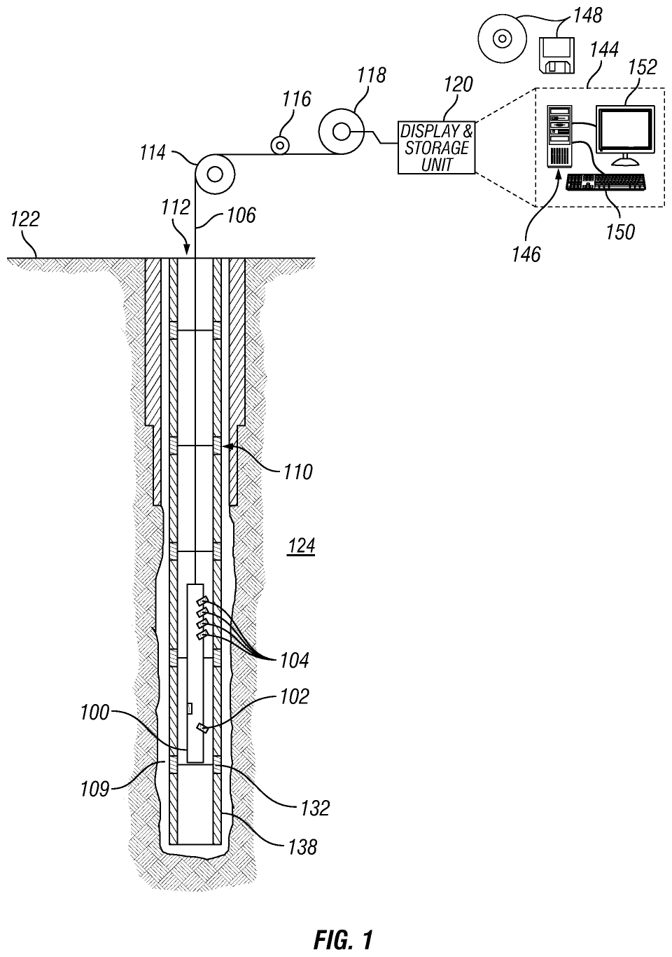

FIG. 1 illustrates an operating environment for an acoustic logging tool 100 as disclosed herein. Acoustic logging tool 100 may comprise a transmitter 102 and/or a receiver 104. In examples, there may be any number of transmitters 102 and/or any number of receivers 104, which may be disponed on acoustic logging tool 100. Acoustic logging tool 100 may be operatively coupled to a conveyance 106 (e.g., wireline, slickline, coiled tubing, pipe, downhole tractor, and/or the like) which may provide mechanical suspension, as well as electrical connectivity, for acoustic logging tool 100. Conveyance 106 and acoustic logging tool 100 may extend within casing string 108 to a desired depth within the wellbore 110. Wellbore 110 may extend vertically or horizontally into formation 124. Conveyance 106, which may include one or more electrical conductors, may exit wellhead 112, may pass around pulley 114, may engage odometer 116, and may be reeled onto winch 118, which may be employed to raise and lower the tool assembly in the wellbore 110.

Signals recorded by acoustic logging tool 100 may be stored on memory and then processed by display and storage unit 120 after recovery of acoustic logging tool 100 from wellbore 110. Alternatively, signals recorded by acoustic logging tool 100 may be conducted to display and storage unit 120 by way of conveyance 106. Display and storage unit 120 may process the signals, and the information contained therein may be displayed for an operator to observe and stored for future processing and reference. Alternatively, signals may be processed downhole prior to receipt by display and storage unit 120 or both downhole and at surface 122, for example, by display and storage unit 120. Display and storage unit 120 may also contain an apparatus for supplying control signals and power to acoustic logging tool 100. Typical casing string 108 may extend from wellhead 112 at or above ground level to a selected depth within a wellbore 110. Casing string 108 may comprise a plurality of joints 130 or segments of casing string 108, each joint 130 being connected to the adjacent segments by a collar 132. There may be any number of layers in casing string 108. For example, a first casing 134 and a second casing 136. It should be noted that there may be any number of casing layers.

FIG. 1 also illustrates a typical pipe string 138, which may be positioned inside annulus 109 of wellbore 110. Pipe string 138 may be production tubing, tubing string, casing string, or another pipe disposed within wellbore 110. Pipe string 138 may comprise concentric pipes. It should be noted that concentric pipes may be connected by collars 132. Acoustic logging tool 100 may be dimensioned so that it may be lowered into the wellbore 110 through pipe string 138.

In logging systems, such as, for example, logging systems utilizing the acoustic logging tool 100, a digital telemetry system may be employed, wherein an electrical circuit may be used to both supply power to acoustic logging tool 100 and to transfer data between display and storage unit 120 and acoustic logging tool 100. A DC voltage may be provided to acoustic logging tool 100 by a power supply located above ground level, and data may be coupled to the DC power conductor by a baseband current pulse system. Alternatively, acoustic logging tool 100 may be powered by batteries located within the downhole tool assembly, and/or the data provided by acoustic logging tool 100 may be stored within the downhole tool assembly, rather than transmitted to the surface during logging (corrosion detection).

Acoustic logging tool 100 may be used for excitation of transmitter 102. As illustrated, one or more receiver 104 may be positioned on the acoustic logging tool 100 at selected distances (e.g., axial spacing) away from transmitter 102. The axial spacing of receiver 104 from transmitter 102 may vary, for example, from about 0 inches (0 cm) to about 40 inches (101.6 cm) or more. In some embodiments, at least one receiver 104 may be placed near the transmitter 102 (e.g., within at least 1 inch (2.5 cm)) while one or more additional receivers may be spaced from 1 foot (30.5 cm) to about 5 feet (152 cm) or more from the transmitter 102. It should be understood that the configuration of acoustic logging tool 100 shown on FIG. 1 is merely illustrative and other configurations of acoustic logging tool 100 may be used with the present techniques. In addition, acoustic logging tool 100 may include more than one transmitter 102 and more than one receiver 104. For example, an array of receivers 104 may be used. Transmitters 102 may include any suitable acoustic source for generating acoustic waves downhole, including, but not limited to, monopole and multipole sources (e.g., dipole, cross-dipole, quadrupole, hexapole, or higher order multi-pole transmitters). Specific examples of suitable transmitters 102 may include, but are not limited to, piezoelectric elements, bender bars, transducers, or other transducers suitable for generating acoustic waves downhole. Receiver 104 may include any suitable acoustic receiver suitable for use downhole, including piezoelectric elements that may convert acoustic waves into an electric signal.

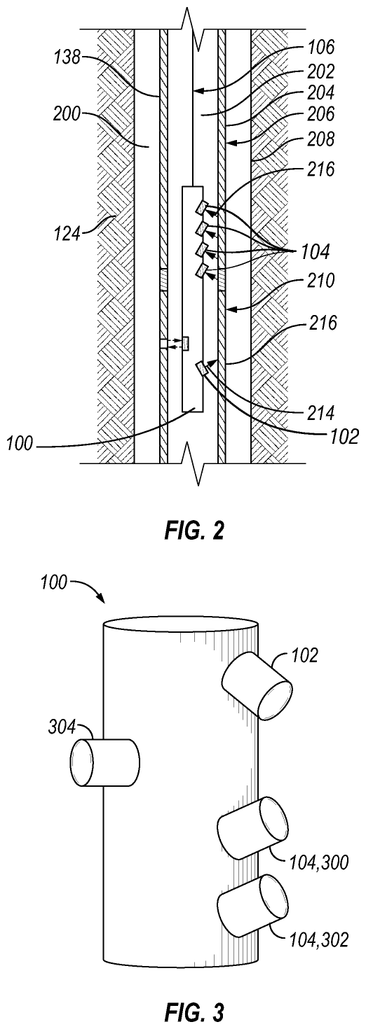

FIG. 2 illustrates acoustic logging tool 100 during logging operations. As illustrated, logging operations (for the methods and systems discussed below) may utilize ultrasonic pulse-echo and pitch catch flexural waves generated from one or more transmitters 102 and recorded by a plurality of receivers 104 to evaluate a condition of a material 200 behind pipe string 138. During operations, logging tool 100 is suspended in mud 202 by conveyance 106. As noted above, to form an acoustic log, ultrasonic pulse-echo and pitch catch flexural waves are generated and recorded. Both waves, which are produced by different systems and methods on acoustic logging tool 100, may be used to analyze material 200 behind pipe string 138. As illustrated, there may be at least three interfaces in which acoustic waves may reflect and/or refract. Those interfaces are a first interface 204, a second interface 206, and third interface 208. First interface 204 is defined as a location in which mud 202 contacts the inner surface of pipe string 138. Second interface 206 is defined as a location in which the outer surface of pipe string 138 contacts with a material 200. Third interface 208 is defined as a location in which material 200 contacts formation 124. For pitch-catch methods 210, transmitters 102 and receivers 104 may be tilted at or about 35 degrees with respect to a longitudinal axis of acoustic tool 100. In examples, the angle may depend on the properties of pipe string 138, mud 202, and application of Snell's law. An angle may be found by applying Snell's law using a phase velocity of a flexural mode of pipe string 138 and a sound speed of mud 202 within pipe string 138. This may allow for generated acoustic wave 214 from transmitter 102 to travel along any of the above identified interfaces and be recorded by receivers 104 as one or more flexural waves 216.

FIG. 3 is a perspective view of acoustic logging tool 100. As illustrated, transmitters 102 and receivers 104 are inverted, as compared to the embodiment in FIGS. 1 and 2. However, acoustic logging tool 100 and the methods described may still operate and function the same way as described above and below. As illustrated, acoustic logging tool 100 may include a transmitter 102 and two or more receivers 104, which may be arranged in a pitch and catch configuration. That is, transmitter 102 may be a pitch transducer, and receivers 104 may be near and far catch transducers spaced at suitable near and far axial distances from transmitter 102, respectively. In such a configuration, transmitter 102 (i.e., may also be referred to as a source pitch transducer) emits sonic or ultrasonic waves while receivers 104 (i.e., may also be referred to as catch transducers) receive the sonic or ultrasonic waves after reflection and/or refraction from the wellbore fluid, casing, cement and formation and record the received waves as time-domain waveforms. Receivers 104 may further be identified as near receiver 300 and far receiver 302. Near receiver 300 being receiver 104 closest to transmitter 102 and far receiver 302 being receiver 104 the furthest away from transmitter 102.

The pitch-catch transducer pairing may have different frequency, spacing, and/or angular orientations based on environmental effects and/or tool design. For example, if transmitter 102 and receivers 104 operate in the sonic range, spacing ranging from three to fifteen feet may be appropriate, with three and five foot spacing may also be suitable. If transmitter 102 and receivers 104 operate in the ultrasonic range, the spacing may be less.

Acoustic logging tool 100 may include, in addition or as an alternative to receivers 104, a pulsed echo ultrasonic transducer 304. Pulsed echo ultrasonic transducer 304 may, for instance, operate at a frequency from 80 kHz up to 800 kHz. The optimal transducer frequency is a function of the casing size, weight, mud environment and other conditions. Pulsed echo ultrasonic transducer 304 transmits waves, receives the same waves after they reflect off of the casing, annular space and formation, and records the waves as time-domain waveforms.

Referring back to FIG. 1, transmission of acoustic waves by the transmitter 102 and the recordation of signals by receivers 104 may be controlled by display and storage unit 120, which may include an information handling system 144. As illustrated, the information handling system 144 may be a component of the display and storage unit 120. Alternatively, the information handling system 144 may be a component of acoustic logging tool 100. An information handling system 144 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may include a processing unit 146 (e.g., microprocessor, central processing unit, etc.) that may process acoustic log data by executing software or instructions obtained from a local non-transitory computer readable media 148 (e.g., optical disks, magnetic disks) The non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146. For example, information handling system 144 may enable an operator to select analysis options, view collected log data, view analysis results, and/or perform other tasks.

As discussed above, data measurements are processed using information handling system 144 (e.g., referring to FIG. 1). For example, as discussed above, there may be a plurality of receivers 104 that measure and record flexural waves 216 as raw waveforms with every acquisition during logging operations. An image may be formed of annulus 109 (e.g., referring to FIG. 1) utilizing information handling system 144 (e.g., referring to FIG. 1) after migrating and stacking the raw waveforms to create a structural map in the time domain. This may allow for the generation of images with higher fidelity in the presence of noise because of the stacking process that is tuned to flatten the secondary flexural wave mode in the pre-stack multi receiver shot gather. The stacking of multi-receiver data is meant to increase signal to noise ratio compared to a single receiver waveform. The following Equations may be utilized to identify a travel time for a secondary flexural mode may be approximated from the raw waveforms measured at receivers 104.

$$t = 2 * \frac{\frac{{d}_{standoff}}{cos {θ}_{0}}}{{vp}_{fluid}} + 2 * \frac{\frac{{d}_{cement}}{cos {θ}_{1}}}{{vp}_{cement}} + \frac{x - 2 * {d}_{standoff} * tan {θ}_{0} - 2 * {d}_{cement} * tan {θ}_{1}}{{vs}_{steel}} \qquad ( 1 )$$

$$t = 2 * \frac{\frac{{d}_{standoff}}{cos {θ}_{0}}}{{vp}_{fluid}} + 2 * \frac{\frac{{d}_{cement}}{cos {θ}_{2}}}{{vs}_{cement}} + \frac{x - 2 * {d}_{standoff} * tan {θ}_{0} - 2 * {d}_{cement} * tan {θ}_{2}}{{vs}_{steel}} \qquad ( 2 )$$

$$t = {t}_{0} + \frac{Δ x}{{vs}_{steel}} \qquad ( 3 )$$

$$\begin{matrix}{t}_{0} = t - p * Δ x & \end{matrix} \qquad ( 4 )$$

For Equations (1)-(4), d_{standoff} and d_{cement} are distance of source transducer (e.g., transmitter 102) from pipe string 138 (e.g., referring to FIG. 1) and cement thickness (e.g., material 200 thickness), respectively. θ₀ and θ₁ are the phase matching angles governing propagation of primary and secondary flexural modes respectively when P wave velocity of cement is lower than phase velocity of flexural wave in casing. θ₂ is the phase matching angle governing propagation of secondary flexural mode when P wave velocity of cement is more than phase velocity of flexural wave in pipe string 138 (e.g., referring to FIG. 1). vp_{fluid}, vp_{cement} and vsₛₜₑₑₗ are the compressional wave velocities in fluid inside pipe string 138 and cement (e.g., material 200) and shear wave velocity in pipe string 138, respectively. vs_{cement} is the shear wave velocity of cement (e.g., material 200).

The travel time for secondary flexural mode may be approximated using the formula in Equation 1 when P wave velocity of material in annulus 109 (e.g., referring to FIG. 1) may be lower compared to the shear wave velocity of pipe string 138 (e.g., referring to FIG. 1) and thus the phase velocity of flexural wave in pipe string 138. In case P wave velocity of material in annulus 109 is higher than phase velocity of flexural waves in pipe string 138, Equation 2 may be used to compute travel time of secondary flexural mode. As discussed above, there may be a plurality of receivers 104 (e.g., referring to FIG. 1). Each receiver 104 may be a distances x₁, x₂, etc. from transmitter 102. In such examples, Equations 1 and/or Equation 2 may be rewritten as Equation 3 with t₀ representing the travel time to a first receiver in the array and Δx representing the offset between receiver 103 under consideration and the first receiver. The first receiver is defined as receiver 103 closest to transmitter 102 in a receiver array. Rearranging Equation 3 and using the definition of ray parameter p, imaging Equation 4 is produced. Equation 4 may be utilized to flatten the secondary flexural wave mode energy in a shot gather which may then be stacked to get a single waveform trace with higher signal to noise ratio. Equation 4 does not make assumptions about the location of discontinuities in annulus 109 and hence the output trace may contain energy that pertains to any discontinuity in annulus 109. If this is repeated for all the shot gathers in a cement evaluation survey and then the stacked trace from each shot acquisition placed together sorted by azimuth and depth, then an image of the annulus in 3D space will may be obtained. Additionally, the above identified operation makes no assumption about the velocity of the media to get the time domain image. The ray parameter p in Equation 4 may be obtained from data itself as:

$$p = \frac{Δ t}{Δ x} \qquad ( 5 )$$

where Δx and Δt may be picked from data recorded by one or more receivers 104 (e.g., referring to FIG. 1). Identification of ray parameter p may be utilized for all other acquisitions.

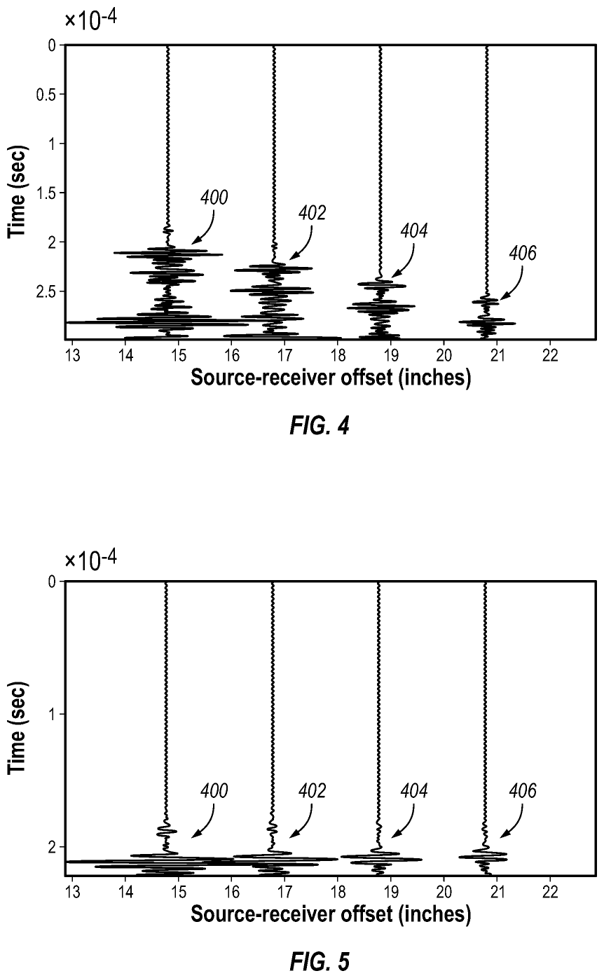

FIG. 4 is a graph of a simulated shot gather with receiver data sorted by source-receiver offset. A source wavelet with central frequency of 250 Khz was used in the full wave equation-based simulation. In these examples, random noise was added to the data after simulation. FIGS. 5-7 show a first trace 400, a second trace 402, a third trace 404, and a fourth trace 406. Each trace is the data recorded at individual receivers 104 (e.g., referring to FIG. 1). The x-axis shows the distance from transmitter 102 to receiver 104 (e.g., referring to FIG. 1) and the y-axis is the time, in seconds, that the measurements were taken.

FIG. 5 is a graph of the simulated data from the shot gather in FIG. 4 in which an operation for a pre-stack gather operation utilizing Equation 3 after a migration operation utilizing Equation 4. Noise added to the shot gather may be observed on individual traces after flattening of the secondary flexural mode energy. The primary flexural mode energy may also be observed on each trace, but the energy levels diminish as the further away a receiver 104 is distanced from transmitter 102. In examples, the secondary flexural mode energy amplitudes may be balanced on a flattened traces based on a decay of the primary flexural mode energy or amplitudes, which may produce a better image generation.

As illustrated in FIG. 5, the primary and secondary flexural waves are located around 2*10⁻⁴ sec. In this example utilizing simulated data, annulus 109 may contained homogeneous material 200 (e.g., referring to FIG. 1), for example, homogenous cement. Thus, the portion of the traces between primary and secondary flexural wave may be relatively silent. In examples, if annulus 109 contained a defect or inhomogeneity in material 200, this may lead to a corresponding signature between primary and secondary waves and thus such imaging may allow for the identification of defects in material 200. This comparison may allow for the disclosed systems and method to identifying defects in material 200.

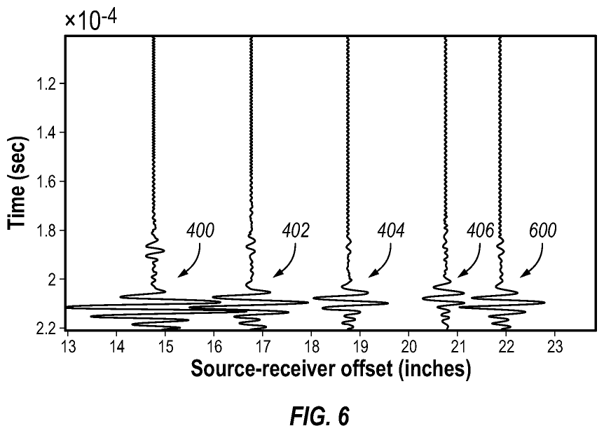

FIG. 6 is a graph of the simulated data from FIG. 5 that combines a pre-stack migrated gather operation (discussed above in FIG. 5) for first trace 400, second trace 402, third trace 404, and fourth trace 406. FIG. 5 illustrates a comparison between the pre-stack migration traces to a final stacked trace 600. Final stacked trace 600 may be found by a migrated gather operations that includes each individual traces that may be cross-correlated to a reference trace, for example first trace 400, to remove any delays that may cause destructive interference in the stacking operation discussed above. The optimally aligned traces may then be taken and each median or mean value may be generated into a final stacked trace 600. Optimally aligned traces is when the secondary flexural wave energy on the migrated traces has a minimal time difference (on the time axis). For example, reviewing the peaks of the wavelets around 2*10∧−4 sec in the individual traces after migration, they are more or less at the same time. If each wavelet stacked together, the wavelets do not cancel out each other and are therefore stacked coherently. A final stacked trace 600 is the median or mean value of the corresponding time samples on the individually migrated and optimally aligned traces.

Noise added to the shot gather may be observed on individual traces after flattening of the secondary flexural mode energy. However, noise is reduced on final stacked trace 600. The primary flexural mode energy may also be observed on first trace 400, second trace 402, third trace 404, and fourth trace 406 but the energy levels diminish as distance increases between receiver 104 and transmitter 102. Furthermore, the primary and secondary flexural waves may be identifiable on final stacked trace 600.

A plurality of final stacked traces 600 may be utilized to form an image. As illustrated in FIG. 6, final stacked trace 600 is for one shot fired at one depth and azimuth combination. The methods described above may be repeated at every depth and azimuth and then the stacked traces from all such locations may be arranged sorted by their depth and azimuth. This allows for the formation of an image. For example, at a depth at or about 1000 ft (about 300 meters), utilizing final stacked traces 600 for all the azimuths and placing them side by side, an azimuthal image may be formed for that depth. In another example, if one azimuth is considered and then final stacked traces 600 obtained at various depths are placed side by side, a depth image at that azimuth may be formed.

The number of receivers 104 may be varied as may the offsets between receivers 104 and transmitter 102 (e.g., referring to FIG. 1) to achieve a similar end goal. Source type and frequency may also be varied without any change to the fundamental idea of imaging with multiple receivers in an array. A wave mode other than secondary flexural wave mode may also be used with the same scheme to image annulus 109 (e.g., referring to FIG. 1).

Improvements over current technology may be inferred from FIGS. 5-7. Improvements may include a stacking process to analyze and understand annulus conditions in the presence of noise as compared to what may be achieved with individual receiver traces.

The idea of utilizing multiple receiver data to image the annulus after migrating and stacking the waveform traces improves data quality and increase signal to noise ratio even under non-ideal conditions. This forms an image of the conditions in the annulus. The image illustrates conditions in the annulus between a pipe string and a formation, including presence of fluid filled defects in the interior of cement and/or other materials, and thus leads to determination of remedial action depending on the identified problem. Remedial action may include, but is not limited to, a squeeze job. A squeeze job may include perforating the pipe string at an area with poor bonding. With access to the poor bonding area, cement may be pumped into the area behind the pipe string to increase the bond between the material and the pipe string.

The preceding description provides various examples of the systems and methods of use disclosed herein which may contain different method steps and alternative combinations of components.

Statement 1: A method for logging may include disposing an acoustic logging tool into a wellbore, insonifing a pipe string within the wellbore with the acoustic logging tool, recording a plurality of flexural waves with the acoustic logging tool as one or more traces, and identifying a condition of a material behind the pipe string using the plurality of flexural waves.

Statement 2: The method of statement 1, further comprising recording the plurality of flexural waves at a plurality of locations by a plurality of receivers disposed on the acoustic logging tool.

Statement 3. The method of statement 1 or 2, further comprising identifying a travel time for a secondary flexural mode.

Statement 4. The method of statement 3, wherein the travel time is found utilizing

$$t = 2 * \frac{\frac{{d}_{standoff}}{cos {θ}_{0}}}{{vp}_{fluid}} + 2 * \frac{\frac{{d}_{cement}}{cos {θ}_{1}}}{{vp}_{cement}} + \frac{x - 2 * {d}_{standoff} * tan {θ}_{0} - 2 * {d}_{cement} * tan {θ}_{1}}{{vs}_{steel}} ,$$

where d_{standoff} is a distance of a transmitter from the pipe string, d_{cement} is a material thickness, θ₀ is a phase angle of a primary flexural mode, θ₁ is a phase angle of a secondary flexural mode, vp_{fluid} is a compressional wave velocity of a fluid in the pipe string, vp_{cement} is a compressional wave velocity in the material behind the pipe string, and vsₛₜₑₑₗ is a compressional wave velocity in the pipe string, and vs_{cement} is a shear wave velocity of the material.

Statement 5. The method of statements 1, 2, or 3, wherein the pre-stack gather and the migration is found utilizing

$$t = 2 * \frac{\frac{{d}_{standoff}}{cos {θ}_{0}}}{{vp}_{fluid}} + 2 * \frac{\frac{{d}_{cement}}{cos {θ}_{2}}}{{vs}_{cement}} + \frac{x - 2 * {d}_{standoff} * tan {θ}_{0} - 2 * {d}_{cement} * tan {θ}_{2}}{{vs}_{steel}} ,$$

where d_{standoff} is a distance of a transmitter from the pipe string, d_{cement} is a material thickness, θ₀ is a phase angle of a primary flexural mode, θ₂ is a phase matching angle of a secondary flexural mode when a P wave velocity of the material is more than a phase velocity of a flexural wave in the pipe string, a phase angle of a secondary flexural mode, vp_{fluid} is a compressional wave velocity of a fluid in the pipe string, vp_{cement} is a compressional wave velocity in the material behind the pipe string, and vsₛₜₑₑₗ is a compressional wave velocity in the pipe string, and vs_{cement} is a shear wave velocity of the material.

Statement 6. The method of statement 5, further comprising flattening a secondary flexural wave mode.

Statement 7. The method of statement 6, wherein the flattening of the secondary flexural wave mode is performed utilizing

t₀=t−p*Δx.

Statement 8. The method of statements 1, 2, 3, or 5, further comprising forming a final stacked trace from the one or more traces.

Statement 9. The method of statement 8, further comprising performing a pre-stack gather, a migration, and a final stacked trace on the plurality of flexural waves.

Statement 10. The method of statement 9, further comprising forming a three-dimensional image of the material behind the pipe string using the final stacked trace.

Statement 11. A system for logging may include an acoustic logging tool. The acoustic logging tool may include one or more transmitters for insonifing a pipe string within a wellbore and one or more receivers configured to record a plurality of flexural waves. The system may further include an information handling system configured to identify a condition of a material behind the pipe string using the plurality of flexural waves.

Statement 12. The system of statement 11, wherein the information handling system is further configured to identify travel time for a secondary flexural mode.

Statement 13. The system of statement 12, wherein the travel time is found utilizing

$$t = 2 * \frac{\frac{{d}_{standoff}}{cos {θ}_{0}}}{{vp}_{fluid}} + 2 * \frac{\frac{{d}_{cement}}{cos {θ}_{1}}}{{vp}_{cement}} + \frac{x - 2 * {d}_{standoff} * tan {θ}_{0} - 2 * {d}_{cement} * tan {θ}_{1}}{{vs}_{steel}} ,$$

where d_{standoff} is a distance of the one or more transmitters from the pipe string, d_{cement} is a material thickness, θ₀ is a phase angle of a primary flexural mode, θ₁ is a phase angle of a secondary flexural mode, vp_{fluid} is a compressional wave velocity of a fluid in the pipe string, vp_{cement} is a compressional wave velocity in the material behind the pipe string, and vsₛₜₑₑₗ a compressional wave velocity in the pipe string, and vs_{cement} is a shear wave velocity of the material.

Statement 14. The system of statements 11 or 12, wherein the pre-stack gather and the migration is found utilizing

$$t = 2 * \frac{\frac{{d}_{standoff}}{cos {θ}_{0}}}{{vp}_{fluid}} + 2 * \frac{\frac{{d}_{cement}}{cos {θ}_{2}}}{{vs}_{cement}} + \frac{x - 2 * {d}_{standoff} * tan {θ}_{0} - 2 * {d}_{cement} * tan {θ}_{2}}{{vs}_{steel}}$$

where d_{standoff} is a distance of the one or more transmitters from the pipe string, d_{cement} is a material thickness, θ₀ is a phase angle of a primary flexural mode, θ₂ is a phase matching angle of a secondary flexural mode when a P wave velocity of the material is more than a phase velocity of a flexural wave in the pipe string, a phase angle of a secondary flexural mode, vp_{fluid} is a compressional wave velocity of a fluid in the pipe string, vp_{cement} is a compressional wave velocity in the material behind the pipe string, and vsₛₜₑₑₗ is a compressional wave velocity in the pipe string, and vs_{cement} is a shear wave velocity of the material.

Statement 15. The system of statement 14, wherein the information handling system is further configured to flatten the secondary flexural wave mode.

Statement 16. The system of statement 15, wherein the flattening of the secondary flexural wave mode is performed utilizing

t₀=t−p*Δx

Statement 17. The system of statements 11, 12, or 14, wherein the information handling system is further configured forming a final stacked trace from the one or more traces.

Statement 18. The system of statement 17, wherein the information handling system is further configured to perform a pre-stack gather, a migration, and a final stacked trace on the plurality of flexural waves.

Statement 19. The system of statement 18, wherein the information handling system is further configured to form a three-dimensional image of the material behind the pipe string using the plurality of flexural waves.

Statement 20. The system of statement 19, wherein the information handling system is further configured to form the three-dimensional image of the material behind the pipe string for a plurality of depths in a wellbore.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for logging comprising:
disposing an acoustic logging tool into a wellbore;
insonifing a pipe string within the wellbore with the acoustic logging tool;
recording a plurality of flexural waves with the acoustic logging tool as one or more traces; and
identifying a condition of a material behind the pipe string using the plurality of flexural waves.

2. The method of claim 1, further comprising recording the plurality of flexural waves at a plurality of locations by a plurality of receivers disposed on the acoustic logging tool.

3. The method of claim 1, further comprising identifying a travel time for a secondary flexural mode.

4. The method of claim 3, wherein the travel time is found utilizing
$$t = 2 * \frac{\frac{{d}_{standoff}}{cos {θ}_{0}}}{{vp}_{fluid}} + 2 * \frac{\frac{{d}_{cement}}{cos {θ}_{1}}}{{vp}_{cement}} + \frac{x - 2 * {d}_{standoff} * tan {θ}_{0} - 2 * {d}_{cement} * tan {θ}_{1}}{{vs}_{steel}} ,$$
where d_{standoff} is a distance of a transmitter from the pipe string, d_{cement} is a material thickness, θ₀ is a phase angle of a primary flexural mode, θ₁ is a phase angle of a secondary flexural mode, vp_{fluid} is a compressional wave velocity of a fluid in the pipe string, vp_{cement} is a compressional wave velocity in the material behind the pipe string, and vsₛₜₑₑₗ is a compressional wave velocity in the pipe string, and vs_{cement} is a shear wave velocity of the material.

5. The method of claim 1, wherein the pre-stack gather and the migration is found utilizing
$$t = 2 * \frac{\frac{{d}_{standoff}}{cos {θ}_{0}}}{{vp}_{fluid}} + 2 * \frac{\frac{{d}_{cement}}{cos {θ}_{2}}}{{vs}_{cement}} + \frac{x - 2 * {d}_{standoff} * tan {θ}_{0} - 2 * {d}_{cement} * tan {θ}_{2}}{{vs}_{steel}} ,$$
where d_{standoff} is a distance of a transmitter from the pipe string, d_{cement} is a material thickness, θ₀ is a phase angle of a primary flexural mode, θ₂ is a phase matching angle of a secondary flexural mode when a P wave velocity of the material is more than a phase velocity of a flexural wave in the pipe string, a phase angle of a secondary flexural mode, vp_{fluid} is a compressional wave velocity of a fluid in the pipe string, vp_{cement} is a compressional wave velocity in the material behind the pipe string, and vsₛₜₑₑₗ is a compressional wave velocity in the pipe string, and vs_{cement} is a shear wave velocity of the material.

6. The method of claim 5, further comprising flattening a secondary flexural wave mode.

7. The method of claim 6, wherein the flattening of the secondary flexural wave mode is performed utilizing
t₀=t−p*Δx.

8. The method of claim 1, further comprising forming a final stacked trace from the one or more traces.

9. The method of claim 8, further comprising performing a pre-stack gather, a migration, and a final stacked trace on the plurality of flexural waves.

10. The method of claim 9, further comprising forming a three-dimensional image of the material behind the pipe string using the final stacked trace.

11. A system for logging comprising:
an acoustic logging tool comprising:
one or more transmitters for insonifing a pipe string within a wellbore; and
one or more receivers configured to record a plurality of flexural waves; and
an information handling system configured to:
identify a condition of a material behind the pipe string using the plurality of flexural waves.

12. The system of claim 11, wherein the information handling system is further configured to identify travel time for a secondary flexural mode.

13. The system of claim 12, wherein the travel time is found utilizing
$$t = 2 * \frac{\frac{{d}_{standoff}}{cos {θ}_{0}}}{{vp}_{fluid}} + 2 * \frac{\frac{{d}_{cement}}{cos {θ}_{1}}}{{vp}_{cement}} + \frac{x - 2 * {d}_{standoff} * tan {θ}_{0} - 2 * {d}_{cement} * tan {θ}_{1}}{{vs}_{steel}}$$
where d_{standoff} is a distance of the one or more transmitters from the pipe string, d_{cement} is a material thickness, θ₀ is a phase angle of a primary flexural mode, θ₁ is a phase angle of a secondary flexural mode, vp_{fluid} is a compressional wave velocity of a fluid in the pipe string, VP_{cement} is a compressional wave velocity in the material behind the pipe string, and vsₛₜₑₑₗ is a compressional wave velocity in the pipe string, and vs_{cement} is a shear wave velocity of the material.

14. The system of claim 11, wherein the pre-stack gather and the migration is found utilizing
$$t = 2 * \frac{\frac{{d}_{standoff}}{cos {θ}_{0}}}{{vp}_{fluid}} + 2 * \frac{\frac{{d}_{cement}}{cos {θ}_{2}}}{{vs}_{cement}} + \frac{x - 2 * {d}_{standoff} * tan {θ}_{0} - 2 * {d}_{cement} * tan {θ}_{2}}{{vs}_{steel}}$$
where d_{standoff} is a distance of the one or more transmitters from the pipe string, d_{cement} is a material thickness, θ₀ is a phase angle of a primary flexural mode, θ₂ is a phase matching angle of a secondary flexural mode when a P wave velocity of the material is more than a phase velocity of a flexural wave in the pipe string, a phase angle of a secondary flexural mode, vp_{fluid} is a compressional wave velocity of a fluid in the pipe string, vp_{cement} is a compressional wave velocity in the material behind the pipe string, and vsₛₜₑₑₗ is a compressional wave velocity in the pipe string, and vs_{cement} is a shear wave velocity of the material.

15. The system of claim 14, wherein the information handling system is further configured to flatten the secondary flexural wave mode.

16. The system of claim 15, wherein the flattening of the secondary flexural wave mode is performed utilizing
t₀=t−p*Δx.

17. The system of claim 11, wherein the information handling system is further configured forming a final stacked trace from the one or more traces.

18. The system of claim 17, wherein the information handling system is further configured to perform a pre-stack gather, a migration, and a final stacked trace on the plurality of flexural waves.

19. The system of claim 18, wherein the information handling system is further configured to form a three-dimensional image of the material behind the pipe string using the plurality of flexural waves.

20. The system of claim 19, wherein the information handling system is further configured to form the three-dimensional image of the material behind the pipe string for a plurality of depths in a wellbore.
